(19) United States
(12) Patent Application Publication
(10) Pub. No.: US 2006/0062202 A1
(43) Pub. Date: Mar. 23, 2006

(54) Method and system for controlling continuous reception of streaming audio using telematics

(75) Inventors: Christopher L. Oesterling, Troy, MI (US); George A. Economos, Sterling Heights, MI (US); Mark S. Schaefer, Sterling Heights, MI (US)

Correspondence Address: ANTHONY LUKE SIMON;GMC, Legal Staff, Mail Code 482-C23-B21, 300 Renaissance Center, P.O. Box 300, Detroit, MI, 48265-3000, US

(73) Assignee: General Motors Corporation.

(21) Appl. No.: 10/946,886

(22) Filed: Sep. 22, 2004

(51) Int. Cl. H04L 12/66

(52) U.S. Cl. 370/352

(57) ABSTRACT

A method for controlling continuous reception of streaming audio using telematics comprising determining subscriber preference input at a call center, determining an IP address at a call center for at least one streaming audio source based on the subscriber preference input, and sending at least one IP address from the call center to a telematics unit.

### FIELD OF THE INVENTION

This invention relates generally to reception of streaming audio. In particular the invention relates to a method and system for controlling continuous reception of streaming audio using telematics.

### BACKGROUND OF THE INVENTION

Mobile vehicles can receive audio through satellite and terrestrial radio broadcasts. Terrestrial radio broadcasts are limited to a particular geographic area. The number of terrestrial radio broadcasts available at any one time is also limited. In an effort to overcome the limits of location and available programming satellite radio was introduced. Satellite radio provides many more stations over a wider geographic area. Satellite radio organizes audio sources into various categories but the information presented is limited and the interface cannot be customized based on user preferences. In addition, purchasing a satellite radio subscriptions is an added expense to subscribers.

The limited programming and location dependence of terrestrial and satellite radio limits their usefulness in mobile vehicles. Many of these radio stations stream their broadcasts over the internet. Other public and private networks exist that can supply a variety of audio types to authorized users. These network-based audio sources can be accessed with the proper equipment. Currently, most mobile vehicles do not have means to access internet-based audio broadcasts or the audio sources available from other public and private networks.

If a mobile vehicle is provided with the proper hardware to access these networks, the management of the available audio sources is normally not feasible while operating the mobile vehicle. Information of interest may require an extensive search before it is located. Syndicated radio shows are available from different sources at varying times. Network-based sources of audio are not always working properly or the programming changes.

Selecting a desired audio source may require sorting through a large number of possible sources. An operator may desire audio sources that are relevant to the geographic area in which the vehicle is located, contain a specific type of programming, or are transmitting a specific genre of music. Even if an operator is able to select the audio sources prior to operating the mobile vehicle, changes cannot be made until the operator again has access to the application that provides for program selection. In addition the operator may want to customize the in-vehicle interface to network-based audio data prior to operating the vehicle.

It is therefore desirable to provide a system and method for controlling continuous reception of streaming audio using telematics that overcomes the limitations, challenges, and obstacles described above.

### SUMMARY OF THE INVENTION

One aspect of the present invention provides a method for controlling continuous reception of streaming audio using telematics comprising determining subscriber preference input at a call center, determining an IP address at a call center for at least one streaming audio source based on the subscriber preference input, and sending at least one IP address from the call center to a telematics unit.

Another aspect of the present invention provides a system for controlling continuous reception of streaming audio using telematics comprising means for determining subscriber preference input at a call center, means for determining an IP address at a call center for at least one streaming audio source based on the subscriber preference input, and means for sending at least one IP address from the call center to a telematics unit.

A third aspect of the present invention provides a computer readable medium storing a computer program including computer readable code for controlling continuous reception of streaming audio using telematics comprising computer program code for determining subscriber preference input at a call center, computer program code for determining an IP address at a call center for at least one streaming audio source based on the subscriber preference input, and computer program code for sending at least one IP address from the call center to a telematics unit.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram representative of one embodiment of a system for controlling continuous reception of streaming audio using telematics, in accordance with the present invention;

FIG. 2 illustrates a flowchart representative of one embodiment of a method for controlling continuous reception of streaming audio using telematics in accordance with the present invention;

FIG. 3 illustrates a flowchart representative of one embodiment of the step of determining an IP address at a call center at 220 of FIG. 2, in accordance with the present invention;

FIG. 4 illustrates a flowchart of one embodiment of the step of sending an IP address from the call center to the telematics unit at 230 of FIG. 2 in accordance with the present invention;

FIG. 5 illustrates a flowchart of another embodiment of the step of sending an IP address from the call center to the telematics unit at 230 of FIG. 2 in accordance with the present invention; and

FIG. 6 illustrates a flowchart representative of one embodiment of a method for processing the streaming audio in a mobile vehicle in accordance with the present invention.

### DETAILED DESCRIPTION OF THE PRESENTLY PREFERRED EMBODIMENTS

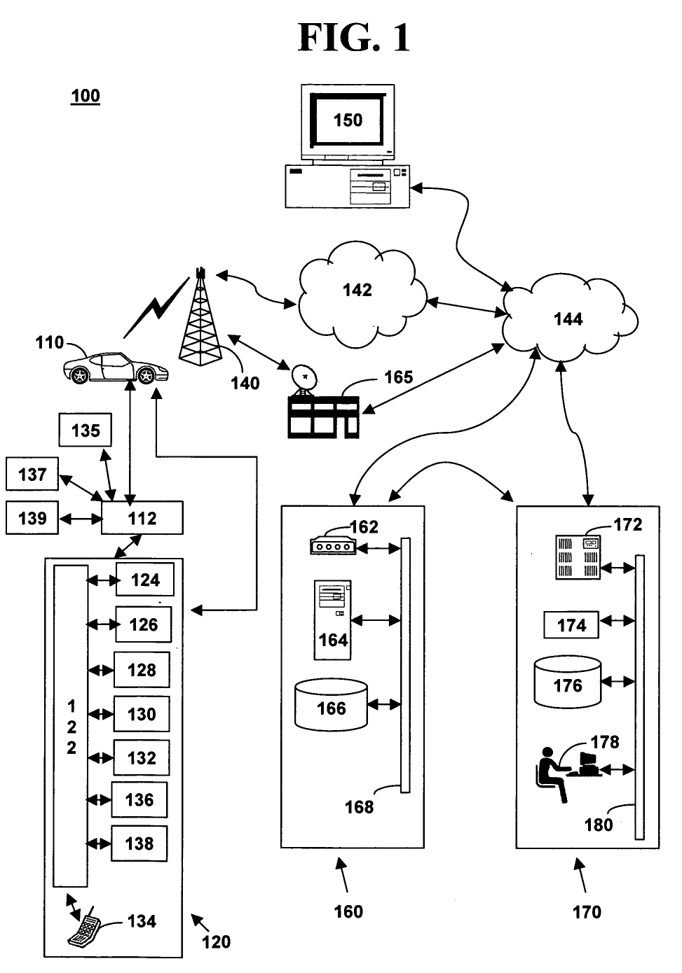

FIG. 1 illustrates one embodiment of system for controlling continuous reception of streaming audio using telematics, in accordance with the present invention at 100. The system for continuous reception of streaming audio using telematics includes a mobile vehicle communication unit (MVCU) 110, a mobile vehicle communication network 112, a telematics unit 120, one or more wireless carrier systems 140, one or more communication networks 142, one or more land networks 144, one or more client, personal, or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion.

MVCU 110 is also referred to as a mobile vehicle in the discussion below. In operation, MVCU 110 may be implemented as a motor vehicle, a marine vehicle, or as an aircraft. A display 135 is embedded in MVCU 110. In one embodiment, the display is a dialed digital display such as a radio unit or an instrument panel. In another embodiment, the display is a navigational display unit. In another embodiment, the display is a heads-up display.

MVCU 110 may include additional components not relevant to the present discussion.

MVCU 110, via a mobile vehicle communication network 112, sends signals to various units of equipment and systems (detailed below) within MVCU 110 to perform various functions such as unlocking a door, opening the trunk, setting personal comfort settings, modifying mobile vehicle functions, and calling from telematics unit 120. In facilitating interactions among the various communication and electronic modules 139, mobile vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, an embedded or in-vehicle mobile phone 134, packet to audio translator 136 and packet data receiver 138. In other embodiments, telematics unit 120 is implemented without one or more of the above listed components such as, for example, GPS unit 126 or speakers 132. Telematics unit 120 can include additional components not relevant to the present discussion.

In various embodiments, processor 122 is implemented as a microcontroller, microprocessor, Digital Signal Processor (DSP), controller, host processor, or mobile vehicle communications processor. In an example, processor 122 is implemented as an application-specific integrated circuit (ASIC). In another embodiment, processor 122 is implemented as a processor working in conjunction with a central processing unit (CPU) performing the function of a general purpose processor. GPS unit 126 provides longitude and latitude coordinates of the mobile vehicle responsive to a GPS broadcast signal received from one or more GPS satellite broadcast systems (not shown). In-vehicle mobile phone 134 is a cellular-type phone such as, for example, an analog, digital, dual-mode, dual-band, multi-mode or multi-band cellular phone.

Packet to audio translator 136 is a device that converts audio data in a packet format to analog or digital audio data that can be played through an in-vehicle multimedia device 137 such as a radio. In one embodiment, packet to audio translator 136 is part of in-vehicle multimedia device 139. In another embodiment, packet to audio translator 136 is part of processor 122. In another embodiment, packet to audio translator 136 is part of telematics unit 120.

A device capable reception at high data rates is required to implement reception of streaming audio in mobile vehicle 110. Packet data receiver 138 is a device capable of receiving broadband wireless transmission of packet data. In one embodiment, packet data receiver 138 is a device that conform to the IS-2000 and GSM 01.60 standards. In one embodiment, packet data receiver 138 is part of in-vehicle multimedia device 139. In another embodiment, packet data receiver 138 is a PCMCIA card connected to vehicle communication network 112. In one embodiment, packet data receiver 138 is part of telematics unit 120.

Processor 122 executes various computer programs that control programming and operational modes of electronic and mechanical systems within MVCU 110. Processor 122 controls communications (e.g., call signals) between telematics unit 120, wireless carrier system 140, and call center 170. In one embodiment, a voice-recognition application is in communication with processor 122 to translate human voice input through microphone 130 to digital signals. Processor 122 generates and accepts digital signals transmitted between telematics unit 120 and a mobile vehicle communication network 112 that is connected to various electronic modules in the mobile vehicle. In one embodiment, these digital signals activate the programming mode and operation modes, as well as provide for data transfers.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, satellite uplink facility 165, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160, satellite uplink facility 165, and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations, and theft alarm settings. For each client, the web server potentially stores hundreds of preferences for wireless mobile vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics unit 120 in MVCU 110 through wireless carrier system 140, communication network 142, land network 144 and web hosting portals 160 using voice transmissions. In an alternative embodiment, communication services manager 174 communicates with telematics unit 120 in MVCU 110 through wireless carrier system 140, communication network 142, land network 144, and web hosting portals 160 using voice transmissions. Switch 172 selects between voice transmissions and data transmissions.

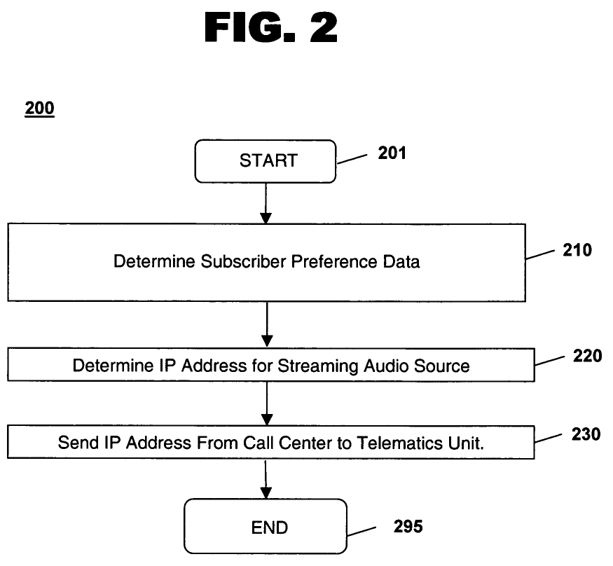

FIG. 2 illustrates a flowchart 200 representative of one embodiment of a method for controlling continuous reception of streaming audio using telematics in accordance with the present invention. The method begins at step 201.

During step 210, a subscriber preference input is determined. In one embodiment, the subscriber preference input is determined at call center 170. Subscriber preference input is, for example, information received from a subscriber that specifies what types of audio the subscriber would like to have available to them. In one embodiment, audio types include music, news, weather, traffic, and talk radio. In one embodiment, subscriber preference input further includes selection criteria such as, for example, a music genre, a type of talk radio, a location for traffic, or a location for weather. In one embodiment, the subscriber preference input is determined when a telematics service request is received at a call center. The subscriber initiates the request through telematics unit 120. In one embodiment, subscriber uses in-vehicle phone 134 to initiate the telematics service request. In another embodiment, the telematics service request is initiated with a button push, or other similar input. Once the telematics service request is received at the call center, the call center requests the subscriber preference input from the subscriber.

During step 220, the call center determines an IP address for at least one streaming audio source based on the subscriber preference input. In another embodiment, the user determines an IOP address for at least one streaming audio source. The IP address specifies the network location of a streaming audio source that meets the subscriber's requirements as communicated to the call center through the subscriber preference input. In one embodiment, a number of streaming audio sources are cataloged with associated IP addresses and audio source characteristics. In such an embodiment, the subscriber preference input is compared with the audio source characteristics, and in the event that the subscriber preference input matches at least one characteristic of at least one audio source, the subscriber preference input is associated with the audio source.

During step 230, at least one IP address is sent from the call center to a telematics unit. In one embodiment, the IP address sent is the IP address determined in step 220. In another embodiment, the IP address is the IP address associated with the audio source that is associated with the subscriber preference input. The telematics unit uses the IP address to access the streaming audio source identified by the call center that includes the content desired by the subscriber. The streaming audio source is accessed through the call center or third party portal.

During step 295, the method terminates.

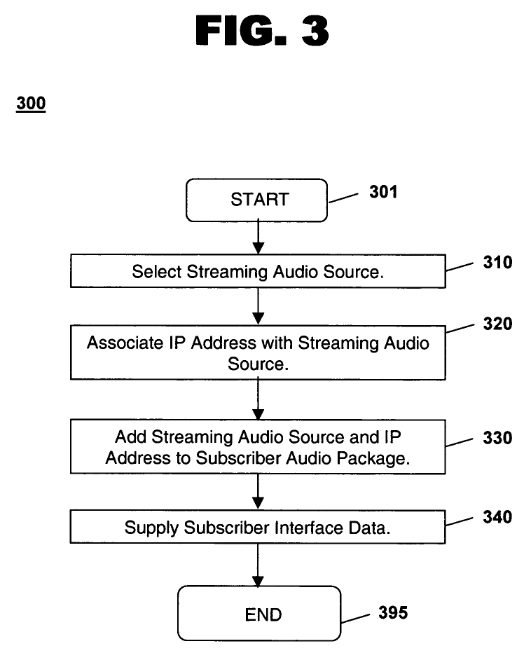

FIG. 3 illustrates a flowchart 300 of the step of determining an IP address at a call center at 220 of FIG. 2 in accordance with one aspect of the present invention. The step detail begins at step 301.

During step 310, at least one streaming audio source is selected based on the subscriber preference input received at the call center. Once the call center receives the telematics service call and determines the subscriber preference input, a list of streaming audio sources that conform to the subscriber preference input is compiled. Streaming audio sources are available from broadcast radio stations that stream or re-broadcast their content over the Internet or other public and private networks. Another example of a streaming audio source is an internet-only radio station, which is a streaming audio source that does not have a terrestrial broadcast frequency. Other streaming audio sources can be provided by the call center or a third party provider and include customized content designed for subscribers only.

A database of streaming audio sources is, in one embodiment, maintained to provide a source for determining which streaming audio sources are consistent with the subscriber preference input. The database of streaming audio sources is maintained at a location in communication with the call center. For example, the database of streaming audio sources is maintained within the call center, in one embodiment. For example, a database of streaming audio sources may include an entry for WGN Radio, a radio station in Chicago, Ill. that is known for news, traffic, weather and talk formats. The entry for WGN radio in the database of streaming audio sources will include associations with an IP address for the WGN Radio streaming audio source, as well as the Chicago area, as well as news, traffic, weather, and talk.

In one embodiment, the list of streaming audio sources based on the subscriber preference data is compiled by and supplied to the mobile vehicle by a third party provider.

During step 320, each streaming audio source is associated with an IP address that corresponds to the network location of the streaming audio data. The IP address allows the telematics unit and associated hardware to directly access the streaming audio source without having to resolve the address from a domain address. When a subscriber preference input matches with a characteristic of at least one streaming audio source in the database of streaming audio sources, the subscriber preference input is associated with the streaming audio source, and its IP address as reflected in the database.

During step 330, the call center creates a subscriber audio package by adding the streaming audio sources selected in step 310 and the corresponding IP addresses from step 320 to the subscriber audio package. The subscriber audio package is a list of the streaming audio sources associated with the subscriber preference input. Each entry in the subscriber audio package includes an IP address associated with a selected streaming audio source. In one embodiment, the call center associates a broadcaster ID, if one is available, with each IP address contained in the subscriber audio package. The broadcaster ID is the call letters assigned to a broadcast radio station or another text string identifying the origin of the streaming audio source.

During step 340, the call center supplies subscriber interface data with each streaming audio source in the subscriber audio package. The subscriber interface data includes information on how the list of streaming audio sources appears to the subscriber. The subscriber interface data includes information on configuring a display interface inside the mobile vehicle, configuring a spoken interface inside the vehicle, or instructions to assign each selected streaming audio source to a button inside the mobile vehicle. Other forms of preference data can be included with the subscriber interface data. The other data includes, for example, the type of audio, the geographic location of the audio source, the name of the broadcast owner, the name of the host or disk jockey, the date of the program contained in the streaming audio and the contact phone number of the program contained in the streaming audio. This data is presented to the subscriber through a visual output such as display 135, or through an audio output such as speaker 132.

During step 395, the method 300 terminates.

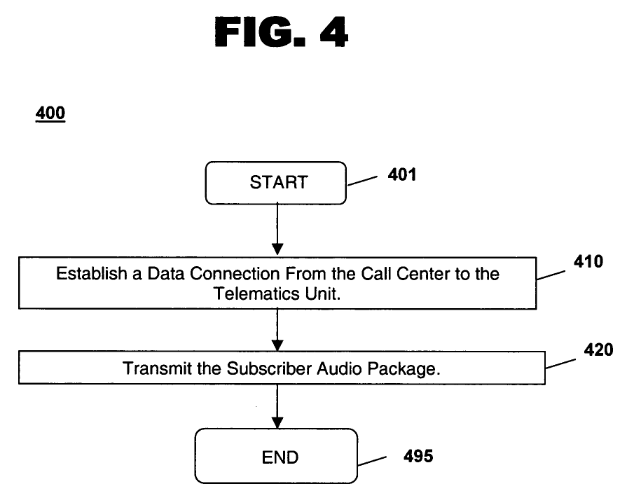

FIG. 4 illustrates a flowchart 400 of one embodiment of the step of sending an IP address from the call center to the telematics unit at 230 of FIG. 2 in accordance with one aspect of the present invention. The step detail begins at step 401.

During step 410, a data connection is established between the call center and the telematics unit. In one embodiment, the data connection is established utilizing the packet data receiver 138. In one embodiment, the data connection is a wireless broadband connection supporting packet-based transmissions.

During step 420, the subscriber audio package is transmitted from the call center to the telematics unit using the established data connection.

During step 495, the method 400 terminates.

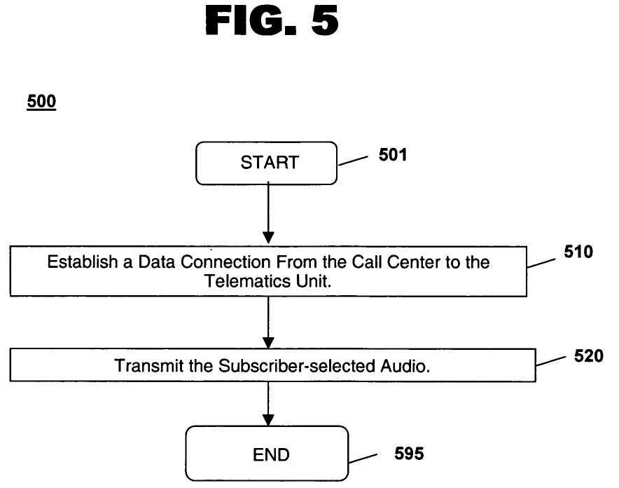

FIG. 5 illustrates a flowchart 500 of another embodiment of the step of sending an IP address from the call center to the telematics unit at 230 of FIG. 2 in accordance with the present invention. The step detail begins at step 501.

During step 510, a data connection is established between the call center and the telematics unit. In one embodiment, the data connection is established utilizing the packet data receiver 138. In one embodiment, the data connection is a wireless broadband connection supporting packet-based transmissions.

During step 520, a subscriber-selected audio is transmitted from the call center to the telematics unit. Subscriber-selected audio is a requested audio source for immediate playback. The subscriber places a telematics service call and requests a particular type of audio programming. The call center then selects a single audio source that fulfills the subscriber's request. The subscriber-selected audio is transmitted directly to the telematics unit where it is played through the in-vehicle radio or multimedia system.

In one embodiment, the call center is the sole interface for selecting and initiating playback of an audio source. No further intervention by the subscriber is required after placing the request. For example, the subscriber preference input requests local news for Chicago. The call center identifies a source of local news for Chicago, e.g. WGN Radio, and transmits an audio stream from WGN Radio to the telematics unit. The telematics unit then directs the audio to the in-vehicle radio. The audio stream may be terminated by direct request of the subscriber, by a request for a different audio stream, or by powering down the telematics unit. The subscriber can also request a different audio type from the call center to supersede the previously selected audio.

During step 595, method 500 terminates.

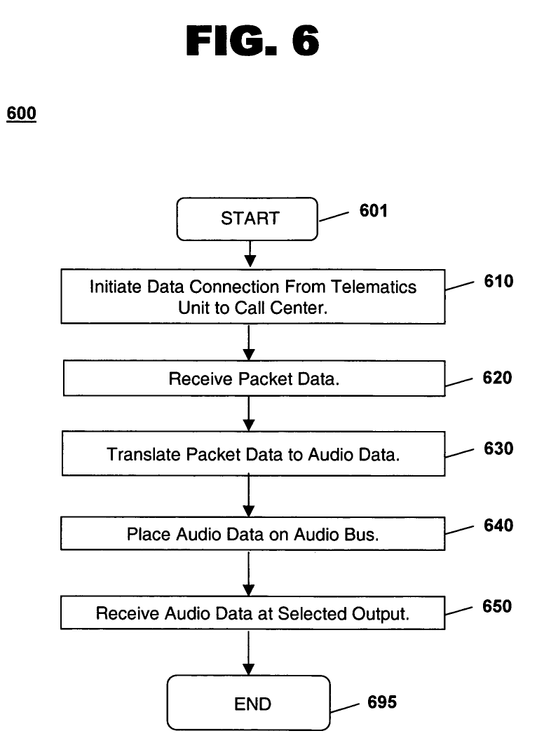

FIG. 6 illustrates a flowchart 600 representative of one embodiment of a method for processing the streaming audio in a mobile vehicle in accordance with one aspect of the present invention. The method begins at step 601.

During step 610, a data connection is initiated from the telematics unit to the call center using an IP address received with a subscriber audio package. In response to the subscriber selecting a streaming audio source, the telematics unit through the associated packet data receiver will initiate a wireless broadband data connection to the IP address at the call center or a third party portal. In one embodiment, the data connection supports data rates of 144 kbps and higher. The IP address will direct the call center or third party portal to the network location of the desired streaming audio source.

During step 620, the mobile vehicle receives audio data from the streaming audio source. Audio data, in one embodiment, is packet data.

During step 630, the packet data is translated to audio data within the mobile vehicle. Translation of the packet data to audio data is with any appropriate protocol, such as MP3, .aiff, .wav, etc. The conversion of packetized data to audio data is well known to those of ordinary skill in the art, and any appropriate means may be used. Processor 122, a vehicle communications processor, or a specialized processor in mobile vehicle 110 handles the translation of the data.

During step 640, the audio data is placed on an audio bus in the mobile vehicle. Once the separate packets of audio data are reassembled into a continuous stream, the audio is in the proper format for playback through the in-vehicle radio, multimedia system, or other audio output device.

During step 650, the audio data is received at a selected device. In one embodiment the selected device is an in-vehicle radio. The selected device is a device capable of playing the audio data through a speaker within the mobile vehicle. The selected device can also be a memory within the mobile vehicle in which the streaming audio is saved and from which the audio data can be recalled for playback at a later time. The selected device can also be a wireless transmission to an MP3 player, cell phone, PDA, or other handheld device. The wireless transmission can be a Bluetooth transmission, 802.11 transmission, or cellular transmission. In another embodiment, the wireless transmission uses any appropriate licensed or unlicensed spectrum. An example of an unlicensed spectrum includes a FCC Part 15 protocol.

During step 695, method 600 terminates.

In addition to determining an IP address, in certain embodiments, a port is also specified. A port is associated with an IP address that features multiple streams of entertainment. In one embodiment, the IP address includes the port. In another embodiment, the port is tracked in conjunction with the IP address. Thus, in the event that an IP address is associated with multiple ports, the methods disclosed herein also track the port. As used herein, the term “IP address” is defined to include the port.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for controlling continuous reception of streaming audio using telematics, the method comprising:
determining subscriber preference input at a call center;
determining an IP address at a call center for at least one streaming audio source based on the subscriber preference input; and
sending at least one IP address from the call center to a telematics unit.

2. The method of claim 1 wherein determining subscriber preference input at a call center comprises:
receiving a telematics service request at the call center; and
requesting the subscriber preference input in response to the received telematics service request.

3. The method of claim 1 wherein determining an IP address for at least one streaming audio source comprises:
selecting at least one streaming audio source based on the subscriber preference input;
associating each streaming audio source with a corresponding IP address;
adding the streaming audio source with the corresponding IP address to a subscriber audio package; and
supplying subscriber interface data along with the subscriber audio package to the telematics unit.

4. The method of claim 1 wherein sending at least one IP address from the call center to the telematics unit comprises:
establishing a data connection between the call center and the telematics unit; and
transmitting the subscriber audio package from the call center to the telematics unit using the data connection.

5. The method of claim 1 wherein sending at least one IP address from the call center to the telematics unit comprises:
establishing a data connection between the call center and the telematics unit; and
transmitting a subscriber selected audio from the call center to the telematics unit using the data connection.

6. The method of claim 1 further comprising:
associating a broadcaster ID with each IP address contained in the subscriber audio package.

7. The method of claim 1 further comprising:
initiating a data connection from the telematics unit to the call center using the received IP address from the subscriber audio package;
receiving packet data comprising the selected streaming audio content at the telematics unit through the call center;
translating the packet data to audio data;
placing the audio data on an audio bus; and
receiving the audio data at a selected output.

8. A system for controlling continuous reception of streaming audio using telematics, the system comprising:
means for determining subscriber preference input at a call center;
means for determining an IP address at a call center for at least one streaming audio source based on the subscriber preference input; and
means for sending at least one IP address from the call center to a telematics unit.

9. The system of claim 8 wherein determining subscriber preference input at a call center comprises:
means for receiving a telematics service request at the call center; and
means for requesting the subscriber preference input in response to the received telematics service request.

10. The system of claim 8 wherein determining an IP address for at least one streaming audio source comprises:
means for selecting at least one streaming audio source based on the subscriber preference input;
means for associating each streaming audio source with a corresponding IP address;
means for adding the streaming audio source with the corresponding IP address to a subscriber audio package; and
means for supplying subscriber interface data along with the subscriber audio package.

11. The system of claim 8 wherein sending at least one IP address from the call center to the telematics unit comprises:
means for establishing a data connection between the call center and the telematics unit; and
means for transmitting the subscriber audio package from the call center to the telematics unit using the data connection.

12. The system of claim 8 wherein sending at least one IP address from the call center to the telematics unit comprises:
means for establishing a data connection between the call center and the telematics unit; and
means for transmitting a subscriber selected audio from the call center to the telematics unit using the data connection.

13. The system of claim 8 further comprising:
means for initiating a data connection from the telematics unit to the call center using the received IP address from the subscriber audio package;
means for receiving packet data comprising the selected streaming audio content at the telematics unit through the call center;
means for translating the packet data to audio data;
means for placing the audio data on an audio bus; and
means for receiving the audio data at a selected output.

14. A computer readable medium storing a computer program including computer program code for controlling continuous reception of streaming audio using telematics, the computer readable medium comprising:
computer program code for determining subscriber preference input at a call center;
computer program code for determining an IP address at a call center for at least one streaming audio source based on the subscriber preference input; and
computer program code for sending at least one IP address from the call center to a telematics unit.

15. The computer readable medium of claim 14 wherein determining subscriber preference input at a call center comprises:
computer program code for receiving a telematics service request at the call center; and
computer program code for requesting the subscriber preference input in response to the received telematics service request.

16. The computer readable medium of claim 14 wherein determining an IP address for at least one streaming audio source comprises:
computer program code for selecting at least one streaming audio source based on the subscriber preference input;
computer program code for associating each streaming audio source with a corresponding IP address;
computer program code for adding the streaming audio source with the corresponding IP address to a subscriber audio package; and
computer program code for supplying subscriber interface data along with the subscriber audio package.

17. The computer readable medium of claim 14 wherein sending at least one IP address from the call center to the telematics unit comprises:
computer program code for establishing a data connection between the call center and the telematics unit; and
computer program code for transmitting the subscriber audio package from the call center to the telematics unit using the data connection.

18. The computer readable medium of claim 14 wherein sending at least one IP address from the call center to the telematics unit comprises:
computer program code for establishing a data connection between the call center and the telematics unit; and
computer program code for transmitting a subscriber selected audio from the call center to the telematics unit using the data connection.

19. The computer readable medium of claim 14 further comprising:
computer program code for associating a broadcaster ID with each IP address contained in the subscriber audio package.

20. The computer readable medium of claim 14 further comprising:
computer program code for initiating a data connection from the telematics unit to the call center using the received IP address from the subscriber audio package;
computer program code for receiving packet data comprising the selected streaming audio content at the telematics unit through the call center;
computer program code for translating the packet data to audio data;
computer program code for placing the audio data on an audio bus; and
computer program code for receiving the audio data at a selected output.
